(19) United States
(12) Patent Application Publication
(10) Pub. No.: US 2024/0380438 A1
(43) Pub. Date: Nov. 14, 2024

(54) WAKE UP SIGNAL (WUS) CONTENT AND DESIGNS FOR RECONFIGURABLE INTELLIGENT SURFACES (RISS)

(71) Applicant: QUALCOMM Incorporated, San Diego, CA (US)

(72) Inventors: Ahmed ELSHAFIE, San Diego, CA (US); Yu ZHANG, San Diego, CA (US); Sony AKKARAKARAN, Poway, CA (US); Alexandros MANOLAKOS, Athens (GR); Seyedkianoush HOSSEINI, San Diego, CA (US); Hwan Joon KWON, San Diego, CA (US)

(21) Appl. No.: 18/684,639

(22) PCT Filed: Oct. 27, 2021
(86) PCT No.: PCT/CN2021/126605

§ 371 Date: Feb. 16, 2024

(51) Int. Cl. H04B 7/04; H04W 52/02

(52) U.S. Cl. CPC H04B 7/04013; H04W 52/0235

(57) ABSTRACT

Certain aspects of the present disclosure relate to wireless communications, and more particularly, to techniques for reconfigurable intelligent surface (RIS) communication using RIS wake up signals (WUSs). A method that may be performed by a RIS includes determining resources for WUS transmissions, based on a WUS resource configuration, receiving, from a node, a WUS transmitted on the determined resources, and determining to wake DETERMINE, BY A RECONFIGURABLE INTELLIGENT SURFACE up a controller of the RIS, a surface of the RIS, or both based on the received WUS.

### BACKGROUND

### Field of the Disclosure

Aspects of the present disclosure relate to wireless communications, and more particularly, to reconfigurable intelligent surface (RIS)-aided communication using RIS wake up signals (WUSs).

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink (DL) channels (e.g., for transmissions from a BS or DU to a UE) and uplink (UL) channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the DL and on the UL. To these ends, NR supports beamforming, multiple-input multiple-output (MIMO) antenna technology, and carrier aggregation.

As the demand for mobile broadband access continues to increase, there exists a need for further improvements in NR and LTE technology. These improvements should be applicable to other multi-access technologies and the telecommunication standards that employ these technologies.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include improved communications between devices in a wireless network.

One or more aspects of the subject matter described in this disclosure can be implemented in a method for wireless communications by a reconfigurable intelligent surface (RIS). The method generally includes determining resources for wake up signal (WUS) transmissions, based on a WUS resource configuration, receiving, from a node, a WUS transmitted on the determined resources, and determining to wake up a controller of the RIS, a surface of the RIS, or both based on the received WUS.

One or more aspects of the subject matter described in this disclosure can be implemented in a method for wireless communications by a node (e.g., a network entity or a user equipment (UE)). The method generally includes determining resources for WUS transmissions, based on a WUS resource configuration and transmitting, to an RIS, a WUS on the determined resources, the WUS indicating whether to wake up a controller of the RIS, a surface of the RIS, or both.

One or more aspects of the subject matter described in this disclosure can be implemented in an apparatus for wireless communication by an RIS. The apparatus generally includes a memory and at least one processor coupled with the memory. The at least one processor coupled with the memory is generally configured to determine resources for WUS transmissions, based on a WUS resource configuration, receive, from a node, a WUS transmitted on the determined resources, and determine to wake up a controller of the RIS, a surface of the RIS, or both based on the received WUS.

One or more aspects of the subject matter described in this disclosure can be implemented in an apparatus for wireless communication by a node (e.g., a network entity or a UE). The apparatus generally includes a memory and at least one processor coupled with the memory. The at least one processor coupled with the memory is generally configured to determine resources for WUS transmissions, based on a WUS resource configuration and transmit, to an RIS, a WUS on the determined resources, the WUS indicating whether to wake up a controller of the RIS, a surface of the RIS, or both.

One or more aspects of the subject matter described in this disclosure can be implemented in an apparatus for wireless communication by an RIS. The apparatus generally includes means for determining resources for WUS transmissions, based on a WUS resource configuration, means for receiving, from a node, a WUS transmitted on the determined resources, and means for determining to wake up a controller of the RIS, a surface of the RIS, or both based on the received WUS.

One or more aspects of the subject matter described in this disclosure can be implemented in an apparatus for wireless communication by a node (e.g., a network entity or a UE). The apparatus generally includes means for determining resources for WUS transmissions, based on a WUS resource configuration and means for transmitting, to an RIS, a WUS on the determined resources, the WUS indicating whether to wake up a controller of the RIS, a surface of the RIS, or both.

One or more aspects of the subject matter described in this disclosure can be implemented in a computer readable medium having computer executable code stored thereon. The computer readable medium having computer executable code stored thereon generally includes code for determining resources for WUS transmissions, based on a WUS resource configuration, code for receiving, from a node, a WUS transmitted on the determined resources, and code for determining to wake up a controller of the RIS, a surface of the RIS, or both based on the received WUS.

One or more aspects of the subject matter described in this disclosure can be implemented in a computer readable medium having computer executable code stored thereon. The computer readable medium having computer executable code stored thereon generally includes code for determining resources for WUS transmissions, based on a WUS resource configuration and code for transmitting, to an RIS, a WUS on the determined resources, the WUS indicating whether to wake up a controller of the RIS, a surface of the RIS, or both.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure, and the description may admit to other equally effective aspects.

FIG. 1 is a block diagram conceptually illustrating an example telecommunications system, including a reconfigurable intelligent surface (RIS), in accordance with certain aspects of the present disclosure.

FIG. 2 is a block diagram conceptually illustrating a design of an example base station (BS), user equipment (UE), and RIS, in accordance with certain aspects of the present disclosure.

FIG. 3A illustrates an example of communication blockage between wireless communication devices, in accordance with certain aspects of the present disclosure.

FIG. 3B illustrates an example of using a RIS to overcome impediment by obstacles between a BS and a UE, in accordance with certain aspects of the present disclosure.

FIG. 4 illustrates an example arrangement of RIS elements, in accordance with certain aspects of the present disclosure.

FIG. 5 is a flow diagram illustrating example operations for wireless communication by an RIS, in accordance with certain aspects of the present disclosure.

FIG. 6 is a flow diagram illustrating example operations for wireless communication by a node, in accordance with certain aspects of the present disclosure.

FIG. 7 illustrates an example RIS wake up signal (WUS) resource configuration, in accordance with certain aspects of the present disclosure.

FIG. 8 is a diagram illustrating an example RIS WUS configuration in combination with a discontinuous reception (DRX) configuration, in accordance with certain aspects of the present disclosure.

FIG. 9 illustrates a communications device that may include various components configured to perform operations for the techniques disclosed herein, in accordance with certain aspects of the present disclosure.

FIG. 10 illustrates a communications device that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for reconfigurable intelligent surface (RIS)-aided communication using RIS wake up signals (WUSs). For example, an RIS may be configured with periodic WUS resources for monitoring for WUSs transmitted by a network node, such as a network entity (e.g., base station (BS)), next generation NodeB (gNB or gNodeB)) or a user equipment (UE). WUSs generally refer to signals that may be provided to indicate to an RIS whether that RIS should wake up (e.g., power up) a surface of the RIS, a controller of the RIS, or both.

Accordingly, the RIS WUS configurations described herein may be used to improve power efficiency in RIS-aided wireless communication by avoiding waking up or keeping an RIS (e.g., a surface, controller, or both) awake unnecessarily. In addition, RIS WUS configurations may be used to reduce interference when multiple RISs are available by using WUSs to control what RISs, or what controllers or surfaces of each RIS, are awake in the RIS-aided wireless communication environment.

The following description provides examples, and is not limiting of the scope, applicability, or examples set forth in the claims. Changes may be made in the function and arrangement of elements discussed. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method, which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 megahertz (MHz) or beyond), millimeter wave (mmW) targeting high carrier frequency (e.g., 25 gigahertz (GHz) or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. Multiple-input multiple-output (MIMO) transmissions with precoding may also be supported. MIMO configurations in the downlink (DL) may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

### Example Wireless Communications System

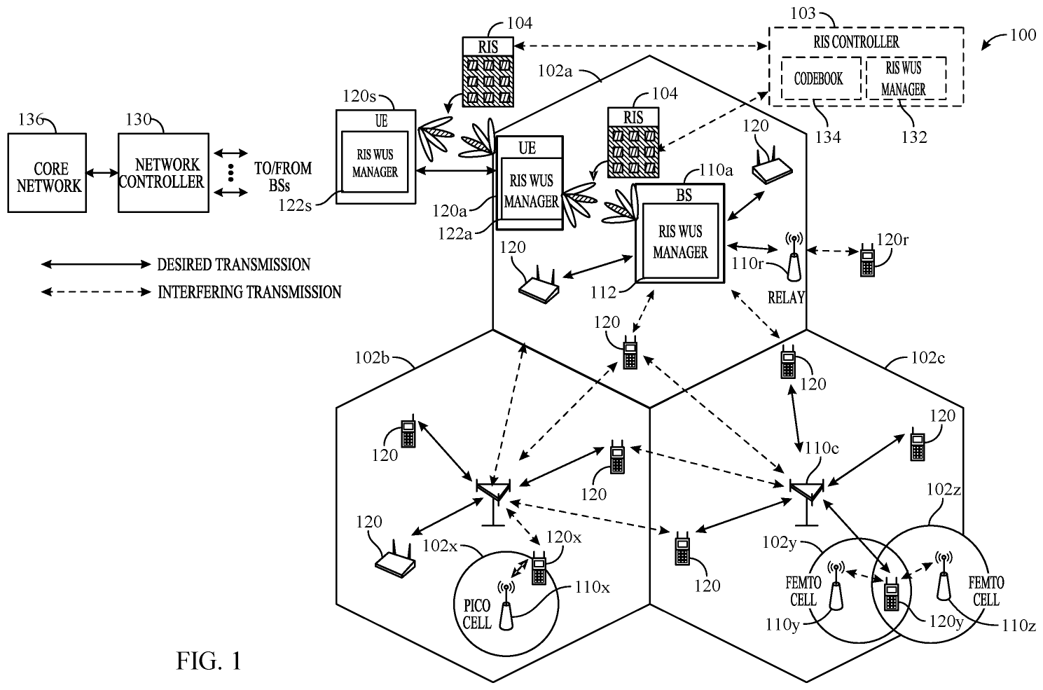

FIG. 1 illustrates an example wireless communication system 100 in which aspects of the present disclosure may be performed. For example, the wireless communication system 100 may be a New Radio (NR) system (e.g., a 5G NR network). As shown in FIG. 1, the wireless communication system 100 may be in communication with a core network 136. The core network 136 may be in communication with one or more BSs 110 and/orUEs 120 in the wireless communication system 100 via one or more interfaces.

As illustrated in FIG. 1, a user equipment (UE), such as UE 120 (e.g., including UEs 120a and 120s) in the wireless communication system 100 communicates with a serving base station (BS) 110, such as BS 110a in cell 102a in the wireless communication system 100. UE 120a may be configured with multiple transmission configurations (e.g., antenna arrays/panels and/or beams) for uplink (UL) transmission to BS 110a. In some cases, UE 120a may be configured with multiple transmission configurations for sidelink transmission to another UE, e.g., UE 120s.

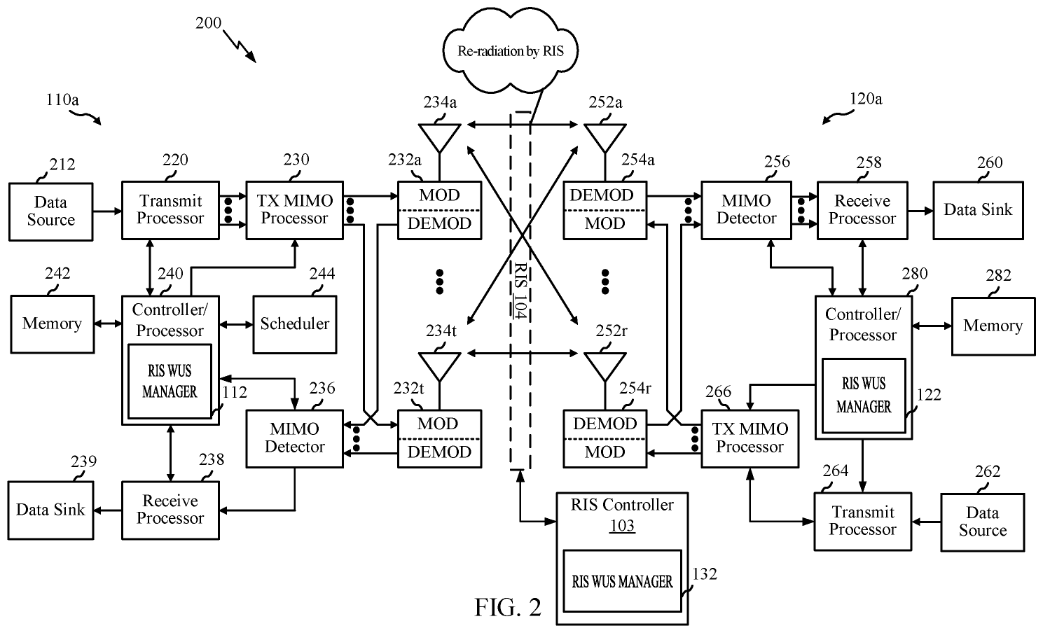

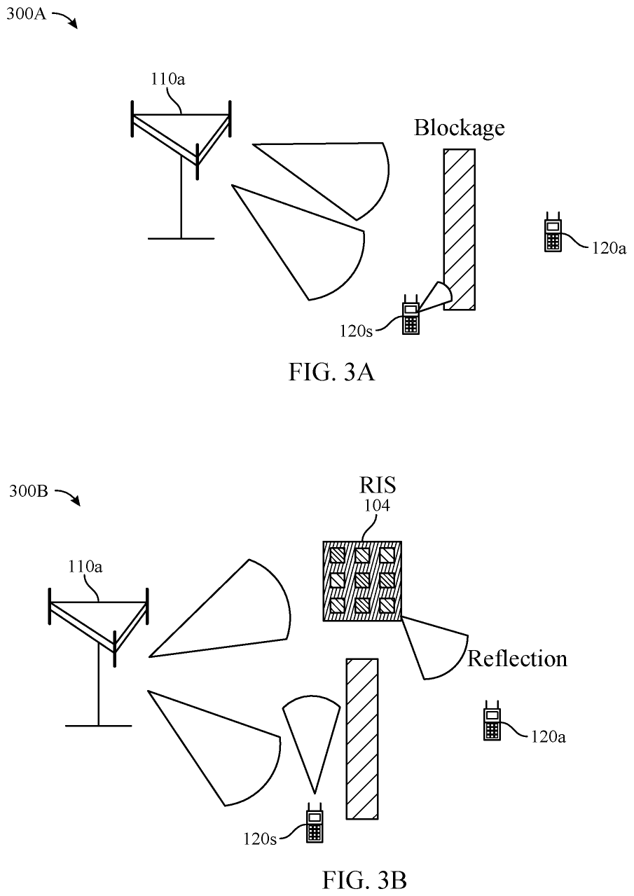

In certain aspects, communication between BS 110a (e.g., next generation NodeB (gNB or gNodeB)) and UE 120a may be blocked by obstacles (e.g., buildings, poles, etc.) and require assistance from a reconfigurable intelligent surface (RIS) 104 (also shown in FIGS. 2 and 3). RIS 104 enables communications between BS 110a and UE 120a to be received and re-radiated, thereby avoiding the obstacles. For example, RIS 104 may be configured with a codebook for precoding one or more elements thereon (referred to as RIS elements) to allow a beam from one of BS 110a or UE 120a (e.g., a transmitter) to be re-radiated off the RIS to reach the other one of BS 110a or UE 120a (e.g., a receiver). The direction of the re-radiation by RIS 104 may be controlled or reconfigured by RIS controller 103 of the RIS 104.

RIS controller 103 includes a codebook 134 for applying a beamformer (e.g., precoding weights) according to RIS elements of RIS 104. Codebook 134 includes values of weights to configure each RIS element (or each group of RIS elements) to modify the radio signal re-radiated by each RIS element, such as weight shifting or changing amplitudes.

In an example, when UE 120a is the transmitter and communicates with BS 110a (e.g., over a wireless Uu interface), BS 110a is the receiver that provides RIS controller 103 feedback for selecting beamformer values for the RIS elements. Similarly, when UE 120a establishes a sidelink (e.g., PC5 interface) with UE 120s, UE 120a may be the transmitter and UE 120s may be the receiver that provides RIS controller 103 feedback. Codebook 134 may be generated based on specific settings of BS 110a and UE 120a, and based on different parameters specific to different situations. The feedback from the receiver to the RIS controller 103 allows for the selection of beamformer values for reflecting communications between the transmitter and the receiver. Other configurations in wireless communication system 100 can be similarly setup between the UEs 120 and BSs 110.

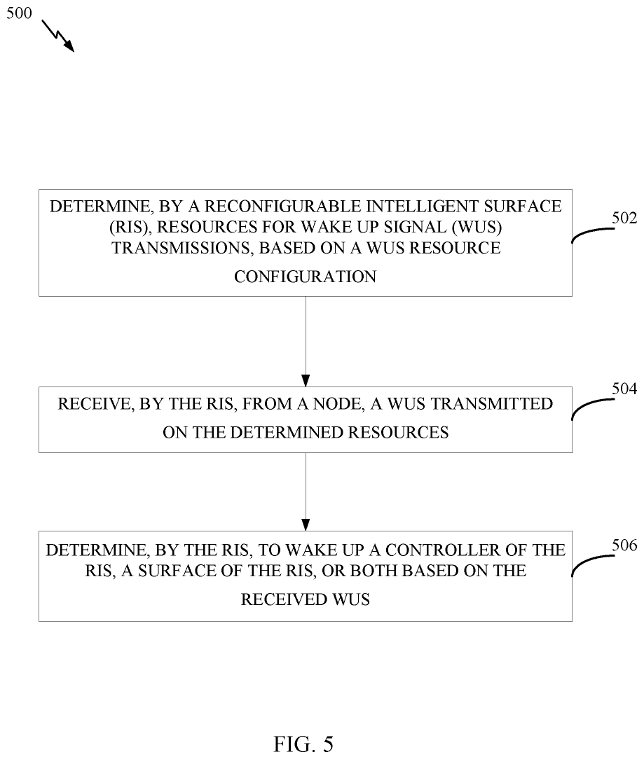

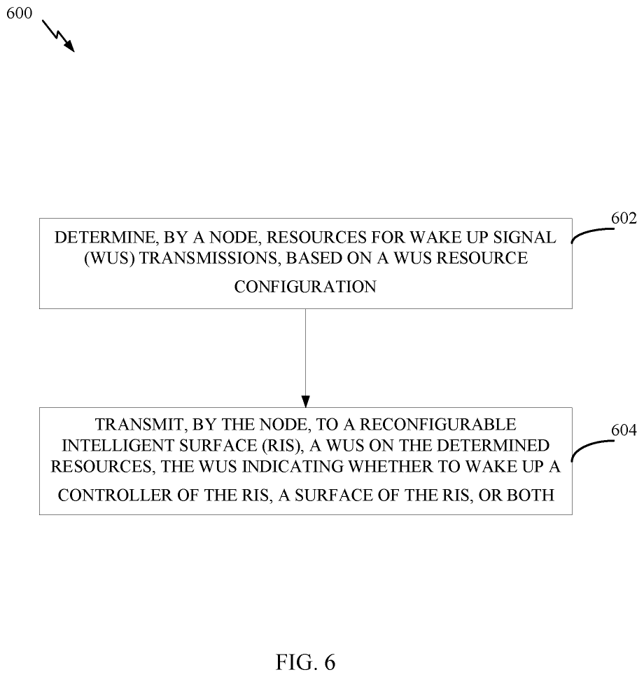

BS 110a, UE 120a, UE 120s (including UE 120s), and/or RIS controller 103 may include an RIS wake up signal (WUS) manager (e.g., RIS WUS manager 112 for BS 110a, RIS WUS manager 122a for UE 120a, RIS WUS manager 122s for UE 120s, and RIS WUS manager 132 for RIS controller 103 for waking up RIS 104 (referred to herein as an RIS 104 or a surface of RIS 104), RIS controller 103, or both. Further, RIS WUS manager 112, 122a, and 122s may be configured to perform operations 600 of FIG. 6, while RIS WUS manager 132 may be configured to perform operations 500 of FIG. 5.

As illustrated in FIG. 1, wireless communication system 100 may include a number of BSs 110 and other network entities. A BS 110 may be a station that communicates with UEs 120. Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and gNB or gNodeB, NR BS, 5G NB, access point (AP), or transmission reception point (TRP) may be interchangeable. In some examples, a cell may not necessarily be stationary, and the geographic area of the cell may move according to the location of a mobile BS. In some examples, BSs 110 may be interconnected to one another and/or to one or more other BSs 110 or network nodes (not shown) in wireless communication system 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS 110 may provide communication coverage for a macro cell, a pico cell, a femto cell, and/or other types of cells. A macro cell may cover a relatively large geographic area (e.g., several kilometers in radius) and may allow unrestricted access by UEs 120 with service subscription. A pico cell may cover a relatively small geographic area and may allow unrestricted access by UEs 120 with service subscription. A femto cell may cover a relatively small geographic area (e.g., a home) and may allow restricted access by UEs 120 having an association with the femto cell (e.g., UEs 120 in a Closed Subscriber Group (CSG), UEs 120 for users in the home, etc.). A BS 110 for a macro cell may be referred to as a macro BS. A BS 110 for a pico cell may be referred to as a pico BS. A BS 110 for a femto cell may be referred to as a femto BS or a home BS. In the example shown in FIG. 1, the BSs 110a, 110b, and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS 110 may support one or multiple (e.g., three) cells.

Wireless communication system 100 may also include relay stations. A relay station is a station that receives a transmission of data and/or other information from an upstream station (e.g., a BS 110 or a UE 120) and sends a transmission of the data and/or other information to a downstream station (e.g., a UE 120 or a BS 110). A relay station may also be a UE 120 that relays transmissions for other UEs 120. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication system 100 may be a heterogeneous network that includes BSs of different types, e.g., macro BS, pico BS, femto BS, relays, etc. These different types of BSs may have different transmit power levels, different coverage areas, and different impact on interference in the wireless communication system 100. For example, macro BS may have a high transmit power level (e.g., 20 Watts) whereas pico BS, femto BS, and relays may have a lower transmit power level (e.g., 1 Watt).

Wireless communication system 100 may support synchronous or asynchronous operation. For synchronous operation, the BSs 110 may have similar frame timing, and transmissions from different BSs 110 may be approximately aligned in time. For asynchronous operation, the BSs 110 may have different frame timing, and transmissions from different BSs 110 may not be aligned in time. The techniques described herein may be used for both synchronous and asynchronous operation.

A network controller 130 may couple to a set of BSs 110 and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120a, 120s, 120x, 120y, etc.) may be dispersed throughout the wireless communication system 100, and each UE 120 may be stationary or mobile. A UE 120 may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs 120 may be considered machine-type communication (MTC) devices or evolved MTC (eMTC) devices. MTC and eMTC UEs include, for example, robots, drones, remote devices, sensors, meters, monitors, location tags, etc., that may communicate with a BS 110, another device (e.g., remote device), or some other entity. A wireless node may provide, for example, connectivity for or to a network (e.g., a wide area network such as Internet or a cellular network) via a wired or wireless communication link. Some UEs 120 may be considered Internet-of-Things (IoT) devices, which may be narrowband IoT (NB-IoT) devices.

Certain wireless networks (e.g., LTE) utilize orthogonal frequency division multiplexing (OFDM) on the downlink (DL) and single-carrier frequency division multiplexing (SC-FDM) on the UL. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (called a “resource block” (RB)) may be 12 subcarriers (or 180 kHz). Consequently, the nominal Fast Fourier Transfer (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.8 MHz (i.e., 6 RBs), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a cyclic prefix (CP) on the UL and DL and include support for half-duplex operation using time division duplexing (TDD). Beamforming may be supported and beam direction may be dynamically configured. Multiple-input multiple-output (MIMO) transmissions with beamformer may also be supported. MIMO configurations in the DL may support up to 8 transmit antennas with multi-layer DL transmissions up to 8 streams and up to 2 streams per UE 120. Multi-layer transmissions with up to 2 streams per UE 120 may be supported. Aggregation of multiple cells may be supported with up to 8 serving cells.

In some examples, access to the air interface may be scheduled. A scheduling entity (e.g., a BS 110) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. BSs 110 are not the only entities that may function as a scheduling entity. In some examples, a UE 120 may function as a scheduling entity and may schedule resources for one or more subordinate entities (e.g., one or more other UEs 120), and the other UEs 120 may utilize the resources scheduled by the UE 120 for wireless communication. In some examples, a UE 120 may function as a scheduling entity in a peer-to-peer (P2P) network, and/or in a mesh network. In a mesh network example, UEs 120 may communicate directly with one another in addition to communicating with a scheduling entity.

In FIG. 1, a solid line with double arrows indicates desired transmissions between a UE 120 and a serving BS 110, which is a BS 110 designated to serve the LIE 120 on the DL and/or UL. A finely dashed line with double arrows indicates interfering transmissions between a UE 120 and a BS 110.

FIG. 2 illustrates example components 200 of BS 110 and UE 120 (as depicted in FIG. 1), which may be used to implement aspects of the present disclosure. As shown, the RIS 104 may assist the communications, by receiving and re-radiating radio signals, between BS 110 and UE 120, such as when such communications are impeded or blocked by obstacles (not shown, illustrated as the blockage in FIGS. 3A and 3B). For example, RIS 104 may re-radiate the transmissions from one of BS 110 or UE 120 to the other using reflection, refraction, or other passive or active mechanisms.

RIS 104 may be reconfigured or controlled by an RIS controller 103. Each RIS element may re-radiate radio signals with certain phase or amplitude changes, such as phase shifts. RIS controller 103 may reconfigure the phase or amplitude changes by applying a beamformer weight to each RIS element or a group of RIS elements to enable RIS 104 to re-radiate an output beam at different directions given a particular input beam. An illustrative deployment example of RIS 104 is shown in FIG. 3B.

Antennas 252, processors 266, 258, 264, and/or controller/processor 280 of the UE 120 and/or antennas 234, processors 220, 230, 238, and/or controller/processor 240 of the BS 110 may be used to perform the various techniques and methods described herein. Although the present disclosure uses RIS as an example of implementing the beamformer techniques, the techniques may apply to another form of cooperative communications, such as transparent relaying or regenerative relaying implementations. As shown in FIG. 2, the controller/processor 280 of UE 120 includes an RIS WUS manager 122 configured to perform operations 600 of FIG. 6 and controller/processor 240 of BS 110 includes an RIS WUS manager 112 configured to perform operations 600 of FIG. 6, as described in more detail herein. Further, RIS controller 103 includes an RIS WUS manager 132 configured to perform operations 500 of FIG. 5.

At BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. Processor 220 may also generate reference symbols, e.g., for the primary synchronization signal (PSS), secondary synchronization signal (SSS), and cell-specific reference signal (CRS). A transmit (TX) MIMO processor 230 may perform spatial processing (e.g., beamformer) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a DL signal. DL signals from modulators 232a through 232t may be transmitted via the antennas 234a through 234t, respectively.

At UE 120, antennas 252a through 252r may receive the DL signals from BS 110 and may provide received signals to the demodulators (DEMODs) in transceivers 254a through 254r, respectively. Each demodulator may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a through 254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the UL, at UE 120, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a through 254r (e.g., for SC-FDM, etc.), and transmitted to BS 110.

At BS 110, the UL signals from UE 120 may be received by the antennas 234, processed by the modulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240.

The controllers/processors 240 and 280 may direct operations at the BS 110 and the UE 120, respectively. The processor 240 and/or other processors and modules at the BS 110 may perform or direct execution of processes for techniques described herein. The memories 242 and 282 may store data and program codes for BS 110 and UE 120, respectively. A scheduler 244 may schedule UEs for data transmission on the DL and/or UL.

While communication between UEs (e.g., UE 120a of FIGS. 1 and 2) and BSs (e.g., BSs 110a of FIGS. 1 and 2) may be referred to as the access link, and the access link may be provided via a Uu interface, communication between devices may be referred to as the sidelink.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which typically use an unlicensed spectrum).

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions.

### Example Application(s) of Reconfigurable Intelligent Surface(s) (RIS(s))

As discussed above, massive multiple input multiple output (MIMO) configuration increases throughput. For example, MIMO can achieve high beamforming gain by using active antenna units and can operate with individual radio frequency (RF) chains for each antenna port. To further such advantages and extend coverage, RISs may be deployed to reflect impinging waves in desired directions. In some cases, RISs may operate without substantial power consumption when they operate passively to only reflect or refract beams from a transmitter towards a receiver. In some cases, the reflection or refraction direction may be controlled by a network entity (e.g., base station (BS), next generation NodeB (gNB or gNodeB)) or a monitoring sidelink user equipment (UE).

FIG. 3A illustrates an example 300A of communication blockage between wireless communication devices, in accordance with certain aspects of the present disclosure. As shown, impeded by a blockage (e.g., blockages such as buildings, terrains, etc.), a network entity, BS 110a (e.g., BS 110a of the wireless communication system 100 of FIG. 1), is only able to transmit to a first UE, UE 120s, as transmissions may not reach a second UE, UE 120a, given the blockage prevents signals from reaching UE 120a. The blockage also prevents UE 120s from establishing sidelink communications with UE 120a. As such, UE 120a is prevented from communicating with BS 110a via UE 120s, using sidelink.

FIG. 3B illustrates an example 300B of using RIS 104 to overcome the blockage, in accordance with certain aspects of the present disclosure. As shown, an RIS 104 is introduced to reflect, or otherwise re-radiate, radio signals to bypass the blockage. For example, two-way communications between BS 110a and UE 120a are enabled by RIS 104 re-radiating one or more beams from BS 110a toward UE 120a, and vice versa. Furthermore, in some cases, RIS 104 is reconfigured, such as with different beamformer values, to enable UEs 120s and 120a to establish sidelink communications.

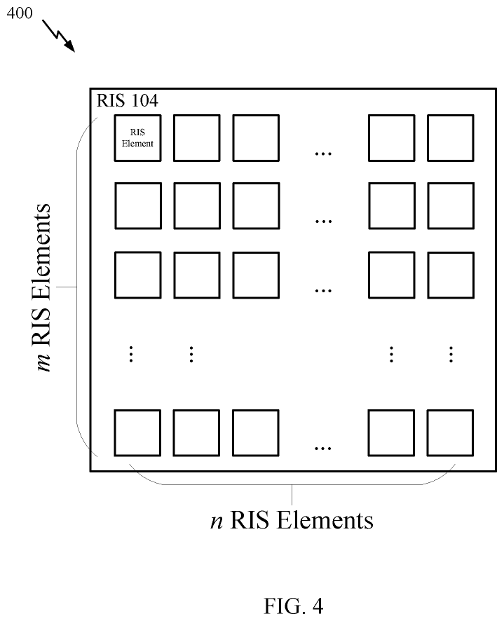

FIG. 4 illustrates an example arrangement 400 of RIS elements (e.g., such as elements of RIS 104 in FIG. 3B), in accordance with certain aspects of the present disclosure. As illustrated in FIG. 4, the surface of RIS 104 consists of any array of discrete elements, such as an m×n rectangular matrix of discrete elements, that can be controlled individually or on a group level. Such elements may enable RIS 104 to perform passive beamforming. For example, RIS 104 may receive signal power from a transmitter (e.g., BS 110a, UE 120a, or UE 120s) proportional to the number of RIS elements thereon. When RIS 104 reflects or refracts the radio signal, elements of RIS 104 cause phase shifts to perform conventional beamforming or beamformer. The phase shifts are controlled by beamformer weights (e.g., a multiplier or an offset of time delay) applied to the elements of RIS 104. In some cases, for the array of RIS elements illustrated in FIG. 4, for example, a respective beamformer weight may be generated or specified for each of the RIS elements by the RIS controller.

Although RISs have been recognized as technology which may improve wireless communication coverage and capacity by intelligently controlling the propagation environment, to realize such benefits, RIS implementations often involve RISs in a constant awake state to aid in the communication. As used herein, an awake state of an RIS may be a state where the surface and controller of the RIS are turned on such that RIS is participating in ongoing activity in the RIS-aided wireless communication environment, including at least, aiding in the reflection and beamforming of one or more transmissions. However, designing RISs such that the controller and surface of the RIS are on at all times significantly increases power consumption at the RIS, and in some cases, increases the likelihood of transmission interference. Accordingly, aspects of the present disclosure provide RIS wake up signal (WUS) configurations used to improve power efficiency and reduce transmission interference in RIS-aided communications.

### Example Wake Up Signal (WUS) Content and Designs for Reconfigurable Intelligent Surfaces (RISs)

The present disclosure provides techniques for configuring reconfigurable intelligent surfaces (RISs) with power savings configurations to allow such RISs to power off one or more components, e.g., a surface and/or controller of the RIS, when not in use in order to save power. In some examples, the power savings configuration may use wake up signals (WUSs). In some examples, the power savings configuration may use a combination of WUSs and discontinuous reception (DRX) cycles.

As will be described in greater detail below, an RIS may be configured with periodic WUS resources for monitoring for WUSs transmitted by a network node, such as a network entity (e.g., base station (BS)), next generation NodeB (gNB or gNodeB), or a user equipment (UE)). WUSs generally refer to signals that may be provided to indicate to an RIS whether that RIS should wake up (e.g., power up) a controller of the RIS, a surface of the RIS, or both. And in cases where the RIS is configured with DRX cycles, WUSs may refer to signals that may provide an indication to the RIS whether that RIS should wake up a controller of the RIS, a surface of the RIS, or both during a subsequent ON duration of a DRX cycle.

RIS WUS configurations described herein may be used to improve power efficiency in RIS-aided wireless communication by reducing an RIS's workload for beamforming, by avoiding waking up or keeping an RIS (e.g., a surface, controller, or both) awake unnecessarily. In addition, RIS WUS configurations may be used to reduce interference when multiple RISs are available. For example, due to the uncontrollable nature of reflections at an RIS when turned on, the likelihood of interference with transmissions across gNBs or within a cell of a gNB with UEs (for example, uplink (UL) transmissions) is significantly increased. Further, in systems deploying multiple RISs, the chances of interference are even greater. Thus, WUSs may be used to control what RISs, or what controllers or surfaces of each RIS, are awake in the RIS-aided wireless communication environment to decrease the potential for interference when multiple RISs are available.

FIG. 5 is a flow diagram illustrating example operations 500 for wireless communication by an RIS, in accordance with certain aspects of the present disclosure. For example, in some cases, operations 500 may be performed by a controller of an RIS, such RIS controller 103 of FIG. 1 and FIG. 2. Although RIS 104 and RIS controller 103 are illustrated as separate and independent devices in FIG. 1 and FIG. 2, in some cases, RIS controller 103 may be integrated with RIS 104. In some cases, UE 120 or BS 110 may perform operations 500 as an RIS controller (e.g., when UE 120 or BS 110 includes an internal RIS controller module).

Operations 500 may be implemented as software components that are executed and run on one or more processors. Further, the transmission and reception of signals by the RIS controller in operations 500 may be enabled, for example, by one or more antennas. In certain aspects, the transmission and/or reception of signals by the RIS controller may be implemented via a bus interface of one or more processors obtaining and/or outputting signals.

Operations 500 begin, at block 502, by the RIS determining resources for WUS transmissions, based on a WUS resource configuration. At block 504, the RIS receives, from a node, a WUS transmitted on the determined resources. The node may be either a network entity synchronized with the RIS, a controlling UE synchronized with the RIS, or a monitoring UE in sidelink communication with the controlling UE. At block 506, the RIS determines to wake up a controller of the RIS, a surface of the RIS, or both based on the received WUS.

FIG. 6 is a flow diagram illustrating example operations 600 for wireless communication by a node, in accordance with certain aspects of the present disclosure.

In some cases, operations 600 may be performed, for example, by a network entity, such as BS 110a in the wireless communication system 100 of FIG. 1. In such cases, operations 600 may be implemented as software components that are executed and run on one or more processors (e.g., controller/processor 240 of FIG. 2). Further, the transmission and reception of signals by the network entity in operations 600 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals.

In some cases, operations 600 may be performed, for example, by a UE, such as UE 120a in the wireless communication system 100 of FIG. 1. In such cases, operations 600 may be implemented as software components that are executed and run on one or more processors (e.g., controller/processor 280 of FIG. 2). Further, the transmission and reception of signals by the UE in operations 600 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

Operations 600 begin, at block 602, by the node determining resources for WUS transmissions, based on a WUS resource configuration. At block 604, the node transmitting, to an RIS, a WUS on the determined resources, the WUS indicating whether to wake up a controller of the RIS, a surface of the RIS, or both.

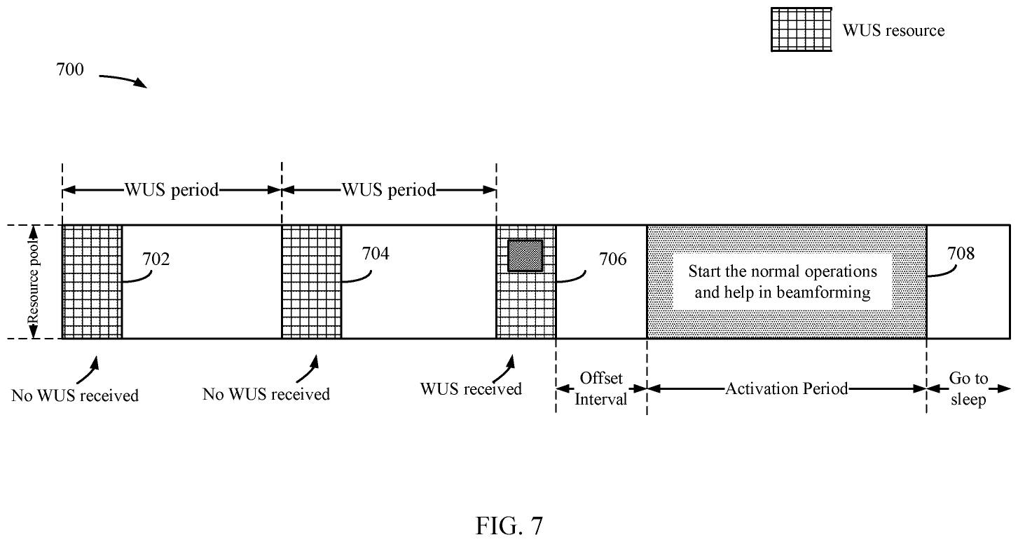

Operations 500 and 600 of FIGS. 5 and 6 may be understood with reference to timeline 700 of FIG. 7 that illustrates an example RIS WUS resource configuration, in accordance with certain aspects of the present disclosure. As illustrated, the RIS WUS resource configuration may include WUS resources 702, 704, 706 for WUS transmissions. In some cases, the RIS may be preconfigured with the WUS resource configuration, such as the WUS resource configuration illustrated in FIG. 7. In some cases, the WUS resource configuration may be configured via radio resource control (RRC) signaling. A WUS resource may repeat every WUS period. In some examples, a RIS may monitor (e.g., wake up in a low power state and monitor) for WUSs from a node in WUS resources 702, 704, 706.

When an RIS does not receive (or detect) a WUS in the WUS monitoring occasion, as illustrated in WUS resources 702 and 704, then the RIS may remain in a sleep state with both the surface and controller of the RIS powered down. However, upon receipt (or detection) of a WUS in a WUS resource, as illustrated in WUS resource 706, then the RIS may determine, at 708, to wake up a controller of the RIS, a surface of the RIS, or both (and start normal operations) based on the received WUS. As described previously, waking up a controller of the RIS, a surface of the RIS, or both may include powering on a controller of the RIS, a surface of the RIS, or both to reflect, or otherwise re-radiate, radio signals (e.g., help in beamforming). In cases where the RIS determines to wake up the controller of the RIS, the RIS may then receive further commands to control the RIS, as needed.

In some cases, only one command may be issued for the controller of the RIS. In this case, the command may be included in the WUS while also indicating to the RIS controller to remain in a sleep state. The RIS controller may subsequently wake up *(e.g., on its own schedule, earlier than a DRX ON duration, or as dictated by the WUS payload) to execute the command contained in the received WUS.

In some cases, the RIS may determine to wake up the controller of the RIS, the surface of the RIS, or both based on a payload of the received WUS. More specifically, the RIS may decode the received WUS, and assuming decoding by the RIS is successful, determine to wake up the controller of the RIS, the surface of the RIS, or both based, at least in part, on a number of bits in the decoded WUS. As an illustrative example, the WUS may include bits “01” indicating to the RIS to wake up (e.g., power on) only a controller of the RIS, bits “10” indicating to the RIS to wake up only a surface of the RIS, orbits “11” indicating to the RIS to wake up both the controller and the surface of the RIS.

According to certain aspects, the WUS may further indicate one or more offset intervals and one or more activation periods for waking up the surface of the RIS, the controller of the RIS, or both. As used herein, and shown in FIG. 7 an offset interval is the period of time between a first time of receiving the WUS in a WUS resource and a second time of waking up (e.g., powering on) the controller of the RIS, the surface of the RIS, or both. In some cases, the offset interval may be zero such that waking up the controller of the RIS, the surface of the RIS, or both occurs immediately after receipt (and successful decoding) of the WUS. In some other cases, the offset interval may be greater than zero such that waking up the controller of the RIS, the surface of the RIS, or both occurs an indicated offset interval after receipt (and successful decoding) of the WUS. Further, as used herein, and shown in FIG. 7, an activation period refers to an amount of time the controller of the RIS, the surface of the RIS, or both are to stay awake, after the offset interval, and before powering down (e.g., returning to a sleep state).

In some cases, the offset interval and the activation period indicated in the WUS for the surface and controller of the RIS may be indicated separately. For example, the WUS may include a first offset interval and a first activation period associated with the surface of the RIS and a second offset interval and a second activation period associated with the controller of the RIS. While the first offset interval and the first activation period indicated in the WUS for the surface of the RIS may be different than the second offset interval and the second activation period indicated in the WUS for the controller of the RIS in some cases, in other cases, the first and second offset intervals may be the same and/or the first and second activation periods may be the same. As an illustrative example, where the WUS indicates to wake up both the surface of the RIS and the controller of the RIS, the WUS may indicate to wake up the surface of the RIS X₁ time after receipt of the WUS and for Y₁ amount of time, while also indicating to wake up the controller of the RIS X₂ time after receipt of the WUS and for Y₂ amount of time, where X₁ and X₂ (e.g., offset intervals) are not equal and Y₁ and Y₂ (e.g., activation periods) are not equal (and X₁, X₂, Y₁, Y₂ are >0). In another illustrative example, where the WUS indicates to wake up both the surface of the RIS and the controller of the RIS, the WUS may indicate to wake up the surface of the RIS X₁ time after receipt of the WUS and for Y₁ amount of time, while also indicating to wake up the controller of the RIS X₂ time after receipt of the WUS and for Y₂ amount of time, where X₁ and X₂ (e.g., offset intervals) are equal and Y₁ and Y₂ (e.g., activation periods) are not equal (and X₁, X₂, Y₁, Y₂ are >0). In such an example, the surface of the RIS and the controller of the RIS may be woken up at the same time, but either the surface or the controller may be powered on for less time than the other based on the values of the activation periods specific to each of the surface and the controller.

In some cases, the offset interval and the activation period indicated in the WUS for the surface and controller of the RIS may be indicated together. For example, the WUS may include a single offset interval and a single activation period to be applied to both the surface of the RIS and the controller of the RIS. Accordingly, the RIS may determine to wake up the surface of the RIS, the controller of the RIS, or both after the indicated, single offset interval and for the single activation period.

In some cases, the RIS may determine to wake up the surface of the RIS, the controller of the RIS, or both based, at least in part, on a default configuration. In particular, the RIS may be pre-configured with a default configuration via RRC signaling or a medium access control (MAC)-control element (MAC-CE). The default configuration may include an activation period and an indication of whether the RIS is to wake up the controller of the RIS, the surface of the RIS, or both for the activation period. Accordingly, in cases where a WUS is received in a WUS resource, the RIS attempts to decode the received WUS and fails to decode, the RIS may determine whether to wake up the controller of the RIS, the surface of the RIS, or both based, at least in part, on such a configuration. The activation period of the default configuration may indicate to the RIS how long the powered on component (e.g., based on the default configuration) is to be powered on for until returning to a sleep state (e.g., turned off or a powered down state). In some cases, the default configuration may further indicate an offset interval.

According to certain aspects, a node (e.g., network entity or UE) may be configured to transmit the WUS multiple times with repetitions. Because a transceiver of the RIS is simple and contains a fewer number of antennas as compared to other entities in the RIS-aided wireless communication environment (e.g., a network entity, UE, etc.), repetition of the WUS may be considered to increase the likelihood of reception by the RIS. While repetition of the WUS may increase the reliability of the WUS reception, WUS repetition may also increase the number of resources/repetitions needed to transmit/receive the WUS more than once.

According to certain aspects, the WUS may be transmitted with multiple repetitions in accordance with a repetition factor and an offset. Accordingly, an RIS may monitor for multiple repetitions of the transmitted WUS based, at least in part, on the repetition factor and the offset. As used herein, the repetition factor refers to an integer specifying the number of times the transmitted WUS is to be repeated. In some cases, the repetition factor is defined per WUS resource, and the RIS determines the repetition factor for the received WUS based, at least in part, on a WUS resource where the WUS was received. Additionally, as used herein, the offset for repetition refers to a period between each transmitted repetition of the WUS. In some examples, the offset may zero such that the WUS is repeated back-to-back. In some examples, the offset may be configured via RRC signaling or a MAC-CE. In some examples, the offset is defined in terms of a number of symbols, sub-slots, or slots. For example, an offset may be defined as three symbols such that an RIS monitors for repetitions of the WUS every three symbols.

For example, referring back to FIG. 7, WUS resources 702, 704, and 706 may be configured by a network entity with a repetition factor. Assuming WUS resource 706 is configured with a repetition factor of three, should a RIS detect a WUS in this WUS resource, the RIS may determine the WUS is to be repeated three times. The RIS may further be configured with an offset for repetition of three symbols, thus, the RIS may determine the WUS is to be repeated three times, where each repetition is expected three symbols apart and monitor for the repeated WUS accordingly.

According to certain aspects, a WUS may be transmitted with multiple repetitions in accordance with a sequence-based scheme. Accordingly, the RIS may monitor for multiple repetitions of the WUS based, at least in part, on the sequence-based scheme. Sequence-based schemes that may be considered include discrete Fourier transform (DFT), Walsh code scheme, golden codes, and the like. Sequence-based schemes may be considered alternative options to the use of polar codes and/or channel coding.

As an example of a sequence-based scheme using a Walsh code, a Walsh matrix may be a 16×16 matrix when four bits are configured to be transmitted (e.g., 24=16). Accordingly, a first row of the matrix corresponding to “00” bits may be [1, 1, 1, 1], a second row of the matrix corresponding to “01” bits may be [1, −1, 1, −1], a third row of the matrix corresponding to “10” bits may be [1, 1, −1, −1], and a fourth row of the matrix corresponding to “11” bits may be [1, −1, −1, 1]. Assuming, in an example, a node determines a surface of the RIS is to be turned on while a controller of the RIS is to remain off, the node may transmit the third row of the matrix (e.g., [1, 1, −1, −1]) corresponding to “10”, where the “1” bit indicates to turn on the surface of the RIS and the “0” bit indicates to turn off the controller of the RIS.

According to certain aspects, the WUS may further include bits indicating weight adjustments to be applied to elements of the RIS to achieve a desired beamforming when the controller of the RIS, the surface of the RIS, or both are awake. In some cases, the WUS may include an explicit indication of the weight adjustment to be applied to elements on the RIS. In some cases, the WUS may include a beam matrix index (e.g., an initial beam matrix) indicating a codebook matrix for determining weight adjustments to be applied to elements on the RIS. The beam matrix index may be based, at least in part, on at least one of a location of the surface of the RIS, a position of the surface of the RIS, or a UE to be served by the RIS (e.g., a UE for which re-radiated/reflected signals at the RIS are intended for).

According to certain aspects, a beamforming index (e.g., weight adjustment to achieve the desired beamforming) may be based on a preconfigured (e.g., predefined) value. Accordingly, in some cases, where a WUS is received by a RIS and the RIS fails to decode the received WUS, the RIS may determine the weight adjustments to be applied to the elements on the RIS to achieve the desired beamforming when the controller of the RIS, the surface of the RIS, or both are awake based, at least in part, on the preconfigured weight adjustment.

According to certain aspects, a WUS may further include an identifier (ID) of a UE to be served by the RIS. When the WUS includes an ID of a UE to be served by the RIS, the RIS may determine a previously used beam for serving the UE associated with the ID in the WUS and determine a beam to use for serving the UE based, at least in part, on the previously used beam. For example, an RIS may have knowledge of a location of a previously served UE and/or beams used to prior serve the UE. Thus, should the RIS receive an ID of the UE to be served, the RIS may have knowledge of weight adjustments to be applied to its elements such that transmissions desired for the identified UE are accurately reflected off the RIS and reach the intended UE.

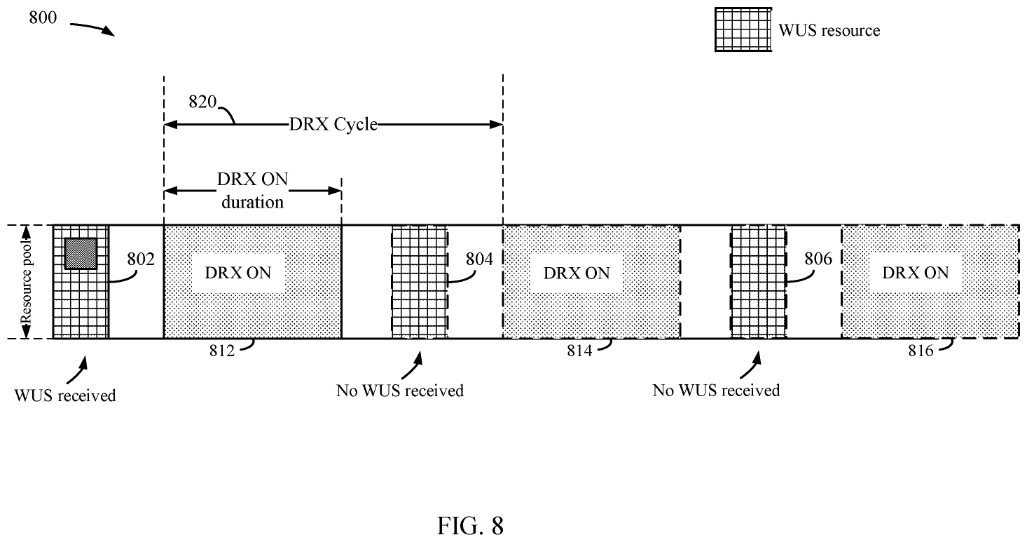

As mentioned previously, in some cases, an RIS may be configured with a combination of WUS resources and DRX cycles. FIG. 8 is a diagram illustrating an example RIS WUS configuration in combination with a DRX configuration, in accordance with certain aspects of the present disclosure.

As illustrated, the DRX configuration 800 may include DRX ON (e.g., awake phase) durations 812, 814, and 816. A DRX ON duration may repeat every DRX cycle. For example, DRX ON duration 812 may be during DRX cycle 820, as illustrated. A surface of an RIS, a controller of an RIS, or both may be awake during DRX ON durations 812, 814, and 816 to aid in beamforming (e.g., re-radiate/reflect transmissions), and asleep at other times (also referred to as DRX OFF durations).

To avoid an RIS waking up or keeping an RIS awake unnecessarily, an RIS may be further configured with a WUS configuration. In other words, jointly configuring an RIS with a WUS and DRX configuration may add an extra layer of power saving before each DRX ON duration. The WUS monitoring occasions may occur (periodically) during a DRX OFF duration of the DRX configuration (also prior to each DRX ON duration). If a WUS is detected during the monitoring in a WUS resource, the RIS may determine to wake up a surface of the RIS, a controller of the RIS, or both during a subsequent DRX ON duration. Further, if a WUS is not detected during the monitoring in the WUS resource, the RIS may not wake up a surface of the RIS, a controller of the RIS, or both in a subsequent DRX ON duration of the DRX configuration (i.e., remain off until a next WUS resource). For example, at WUS resource 802, the RIS may receive (and successfully decode) a WUS and determine to wake up a surface of the RIS, a controller of the RIS, or both for DRX ON duration 812. However, at WUS resource 804 and WUS resource 806, the RIS may not receive a WUS, thus both the surface of the RIS and the controller of the RIS may remain in a sleep state during DRX ON durations 814 and 816, respectively.

According to certain aspects, WUSs may be transmitted to a RIS by a node, including a network entity synchronized with the RIS, a controlling UE synchronized with the RIS, or a monitoring UE in sidelink communication with the controlling UE. When the transmitting node is a monitoring UE, the monitoring UE may act as a relay UE between the controlling UE and the RIS. For example, a controlling UE may transmit a WUS to a monitoring UE, and the monitoring UE may forward the WUS to the RIS. In cases where the node is a network entity synchronized with the RIS, the WUS may be transmitted in a physical downlink control channel (PDCCH). In cases where the node is a controlling UE or a monitoring UE, the WUS may be transmitted in a physical sidelink control channel (PSCCH) or a physical sidelink shared channel (PSSCH). In the PSCCH or the PSSCH, the WUS may be carried in special resources used for indicating the WUS to the RIS.

### Example Wireless Communications Devices

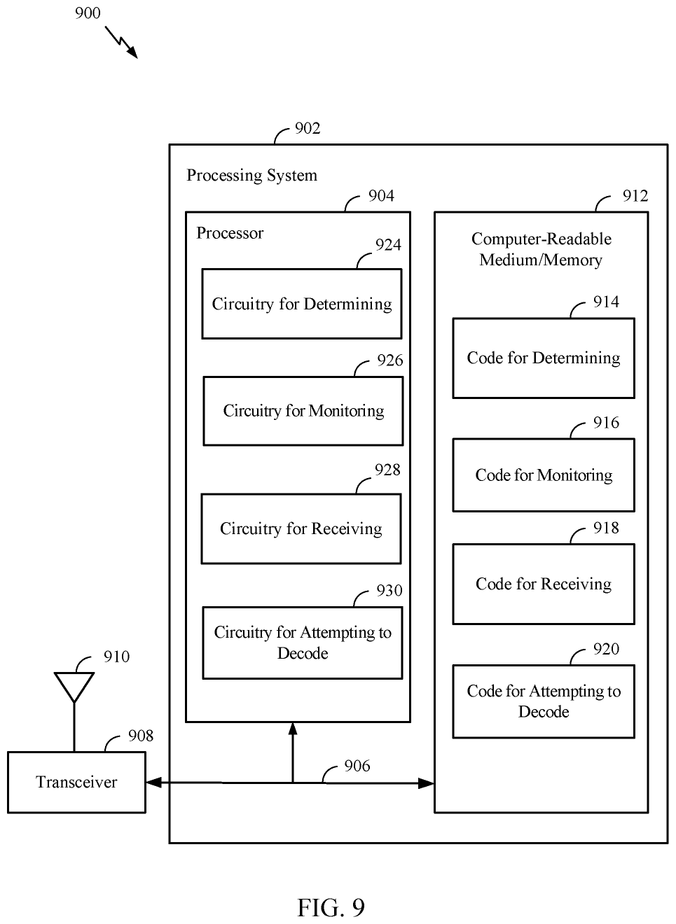

FIG. 9 illustrates a communications device 900 that may include various components (e.g., corresponding to means-plus-function components) configured to perform operations for the techniques disclosed herein, such as the operations illustrated in FIG. 5. In some examples, communications device 900 may be a reconfigurable intelligent surface (RIS) controller such as RIS controller 103, as described with respect to FIG. 1 and FIG. 2.

Communications device 900 includes a processing system 902 coupled to a transceiver 908 (e.g., a transmitter and/or a receiver). Transceiver 908 is configured to transmit and receive signals for the communications device 900 via an antenna 910, such as the various signals as described herein. Processing system 902 may be configured to perform processing functions for communications device 900, including processing signals received and/or to be transmitted by communications device 900.

Processing system 902 includes a processor 904 coupled to a computer-readable medium/memory 912 via a bus 906. In certain aspects, computer-readable medium/memory 912 is configured to store instructions (e.g., computer-executable code) that when executed by processor 904, cause processor 904 to perform the operations illustrated in FIG. 5, or other operations for performing the various techniques discussed herein for reconfigurable intelligent surface (RIS) communication using RIS wake up signals (WUSs). In some cases, the processor 904 can include one or more components of BS 110 with reference to FIG. 2 such as, for example, controller/processor 240 (including the RIS WUS manager 112), transmit processor 220, receive processor 238, and/or the like. Additionally, in some cases, the computer-readable medium/memory 912 can include one or more components of BS 110 with reference to FIG. 2 such as, for example, memory 242 and/or the like.

In certain aspects, computer-readable medium/memory 912 stores code 914 for determining, code 916 for monitoring, code 918 for receiving, and code 920 for attempting to decode.

In some cases, code 914 for determining may include code for determining resources for wake up signal (WUS) transmissions, based on a WUS resource configuration. In some cases, code 914 for determining may include code for determining to wake up a controller of the RIS, a surface of the RIS, or both based on the received WUS. In some cases, code 914 for determining may include code for determining the repetition factor for the received WUS based, at least in part, on a WUS resource where the WUS was received. In some cases, code 914 for determining may include code for determining a previously used beam for serving the UE associated with the ID and determining a beam to use for serving the UE based, at least in part, on the previously used beam.

In some cases, code 916 for monitoring may include code for monitoring for the multiple repetitions of the WUS based, at least in part, on a repetition factor and an offset. In some cases, code 916 for monitoring may include code for monitoring for multiple repetitions of the WUS based, at least in part, on a sequence-based scheme.

In some cases, code 918 for receiving may include code for receiving, from a node, a WUS transmitted on the determined resources.

In some cases, code 920 for attempting to decode may include code for attempting to decode the received WUS.

In certain aspects, processor 904 has circuitry configured to implement the code stored in the computer-readable medium/memory 912. For example, processor 904 includes circuitry 924 for determining, circuitry 926 for monitoring, circuitry 928 for receiving, and circuitry 930 for attempting to decode.

In some cases, circuitry 924 for determining may include circuitry for determining resources for WUS transmissions, based on a WUS resource configuration. In some cases, circuitry 924 for determining may include circuitry for determining to wake up a controller of the RIS, a surface of the RIS, or both based on the received WUS. In some cases, circuitry 924 for determining may include circuitry for determining the repetition factor for the received WUS based, at least in part, on a WUS resource where the WUS was received. In some cases, circuitry 924 for determining may include circuitry for determining a previously used beam for serving the UE associated with the ID and determining a beam to use for serving the UE based, at least in part, on the previously used beam.

In some cases, circuitry 926 for monitoring may include circuitry for monitoring for the multiple repetitions of the WUS based, at least in part, on a repetition factor and an offset. In some cases, circuitry 926 for monitoring may include circuitry for monitoring for multiple repetitions of the WUS based, at least in part, on a sequence-based scheme

In some cases, circuitry 928 for receiving may include circuitry for receiving, from a node, a WUS transmitted on the determined resources.

In some cases, circuitry 930 for attempting to decode may include circuitry for attempting to decode the received WUS.

In some cases, the operations illustrated in FIG. 5, as well as other operations described herein for RIS communication using RIS WUSs, may be implemented by one or means-plus-function components. For example, in some cases, such operations may be implemented by means for determining, means for monitoring, means for receiving (or means for obtaining), and means for attempting to decode.

In some cases, means for receiving (or means for obtaining) includes a receiver (such as the receive processor 238) and/or an antenna(s) 234 of the BS 110 illustrated in FIG. 2 and/or circuitry 928 for receiving of the communication device 900 in FIG. 9.

In some cases, means for configuring, means for determining, means for monitoring, and means for attempting to decode, includes a processing system, which may include one or more processors, such as the receive processor 238, the transmit processor 220, the TX MIMO processor 230, and/or the controller/processor 240 of the BS 110 illustrated in FIG. 2 and/or the processing system 902 of the communication device 900 in FIG. 9.

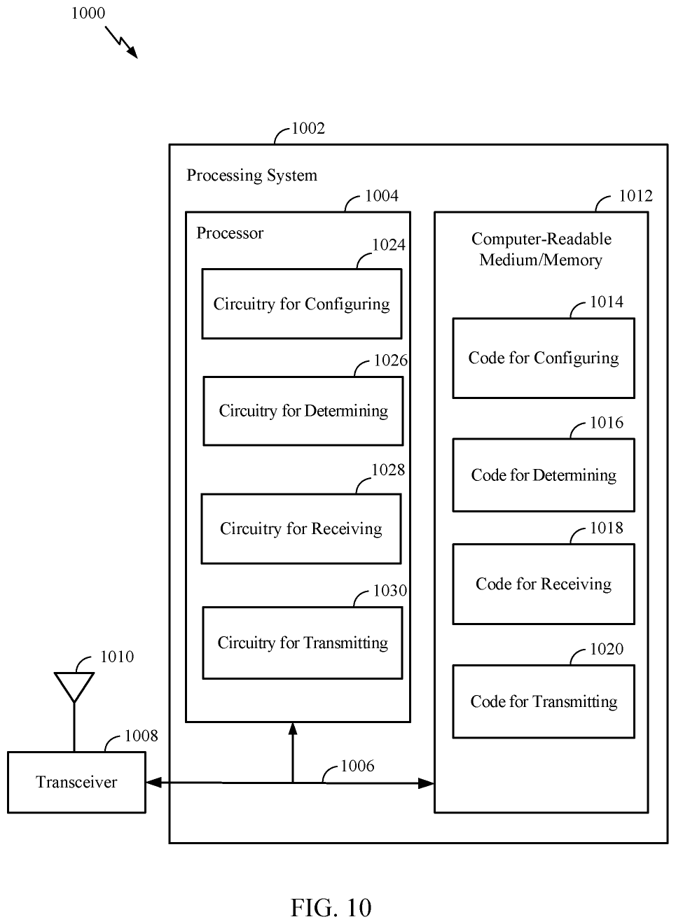

FIG. 10 illustrates a communications device 1000 that may include various components (e.g., corresponding to means-plus-function components) configured to perform operations for the techniques disclosed herein, such as the operations illustrated in FIG. 6.

Communications device 1000 includes a processing system 1002 coupled to a transceiver 1008 (e.g., a transmitter and/or a receiver). Transceiver 1008 is configured to transmit and receive signals for the communications device 1000 via an antenna 1010, such as the various signals as described herein. Processing system 1002 may be configured to perform processing functions for communications device 1000, including processing signals received and/or to be transmitted by communications device 1000.

Processing system 1002 includes a processor 1004 coupled to a computer-readable medium/memory 1012 via a bus 1006. In certain aspects, computer-readable medium/memory 1012 is configured to store instructions (e.g., computer-executable code) that when executed by processor 1004, cause processor 1004 to perform the operations illustrated in FIG. 6, or other operations for performing the various techniques discussed herein for RIS communication using RIS WUSs.

In some cases, the processor 1004 can include one or more components of UE 120 with reference to FIG. 2 such as, for example, controller/processor 280 (including the RIS WUS manager 122), transmit processor 264, receive processor 258, and/or the like. Additionally, in some cases, the computer-readable medium/memory 912 can include one or more components of UE 120 with reference to FIG. 2 such as, for example, memory 282 and/or the like.

In some cases, the processor 1004 can include one or more components of BS 110 with reference to FIG. 2 such as, for example, controller/processor 240 (including the RIS WUS manager 112), transmit processor 220, receive processor 238, and/or the like. Additionally, in some cases, the computer-readable medium/memory 1012 can include one or more components of BS 110 with reference to FIG. 2 such as, for example, memory 242 and/or the like.

In certain aspects, computer-readable medium/memory 1012 stores code 1014 for configuring, code 1016 for determining, code 1018 for receiving, and code 1020 for transmitting.

In some cases, code 1014 for configuring may include code for configuring the RIS with the offset via radio resource control (RRC) signaling or a medium access control (MAC)-control element (MAC-CE).

In some cases, code 1016 for determining may include code for determining resources for WUS transmissions, based on a WUS resource configuration.

In some cases, code 1018 for receiving may include code for receiving the WUS from the controlling UE.

In some cases, code 1020 for transmitting may include code for transmitting, to an RIS, a WUS on the determined resources, the WUS indicating whether to wake up a controller of the RIS, a surface of the RIS, or both.

In certain aspects, processor 1004 has circuitry configured to implement the code stored in the computer-readable medium/memory 1012. For example, processor 1004 includes circuitry 1024 for configuring, circuitry 1026 for determining, circuitry 1028 for receiving, and circuitry 1030 for transmitting.

In some cases, circuitry 1024 for configuring may include circuitry for configuring the RIS with the offset via RRC signaling or a MAC-CE.

In some cases, circuitry 1026 for determining may include circuitry for determining resources for WUS transmissions, based on a WUS resource configuration.

In some cases, circuitry 1028 for receiving may include circuitry for receiving the WUS from the controlling UE.

In some cases, circuitry 1030 for transmitting may include circuitry for transmitting, to an RIS, a WUS on the determined resources, the WUS indicating whether to wake up a controller of the RIS, a surface of the RIS, or both.

In some cases, the operations illustrated in FIG. 6, as well as other operations described herein for RIS communication using RIS WUSs, may be implemented by one or means-plus-function components. For example, in some cases, such operations may be implemented by means for configuring, means for determining, means for receiving (or means for obtaining), and means for transmitting (or means for outputting for transmission).

In some cases, means for transmitting (or means for outputting for transmission) includes a transmitter (such as the transmit processor 264) and/or an antenna(s) 252 of UE 120 illustrated in FIG. 2 and/or circuitry 1030 for transmitting of the communication device 1000 in FIG. 10. In some cases, means for transmitting (or means for outputting for transmission) includes a transmitter (such as the transmit processor 220) and/or an antenna(s) 234 of BS 110 illustrated in FIG. 2 and/or circuitry 1030 for transmitting of the communication device 1000 in FIG. 10.

In some cases, means for receiving (or means for obtaining) includes a receiver (such as the receive processor 258) and/or an antenna(s) 252 of UE 120 illustrated in FIG. 2 and/or circuitry 1028 for receiving of the communication device 1000 in FIG. 10. In some cases, means for receiving (or means for obtaining) includes a receiver (such as the receive processor 238) and/or an antenna(s) 234 of BS 110 illustrated in FIG. 2 and/or circuitry 1028 for receiving of the communication device 1000 in FIG. 10

RIS WUS manager 112, 122a, 122s, and 132 may support wireless communication in accordance with examples as disclosed herein.

RIS WUS manager 112, 122a, 122s, and 132 may be an example of means for performing various aspects described herein. RIS WUS manager 112, 122a, 122s, and 132, or its sub-components, may be implemented in hardware (e.g., in uplink (UL) resource management circuitry). The circuitry may comprise of processor, DSP, an ASIC, a FPGA or other programmable logic device, discrete gate or transistor logic, discrete hardware components, or any combination thereof designed to perform the functions described in the present disclosure.

In another implementation, RIS WUS manager 112, 122a, 122s, and 132, or its sub-components, may be implemented in code (e.g., as configuration management software or firmware) executed by a processor, or any combination thereof. If implemented in code executed by a processor, the functions of RIS WUS manager 112, 122a, 122s, and 132, or its sub-components may be executed by a general-purpose processor, a DSP, an ASIC, a FPGA or other programmable logic device.

In some examples, RIS WUS manager 112, 122a, 122s, and 132 may be configured to perform various operations (e.g., receiving, determining, transmitting) using or otherwise in cooperation with the transceiver 908 or 1008.

RIS WUS manager 112, 122a, 122s, and 132, or its sub-components, may be physically located at various positions, including being distributed such that portions of functions are implemented at different physical locations by one or more physical components. In some examples, RIS WUS manager 112, 122a, 122s, and 132, or its sub-components, may be a separate and distinct component in accordance with various aspects of the present disclosure. In some examples, RIS WUS manager 112, 122a, 122s, and 132, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

### Example Clauses

Implementation examples are described in the following numbered clauses:

Clause 1: A method for wireless communication by a reconfigurable intelligent surface (RIS), comprising: determining resources for wake up signal (WUS) transmissions, based on a WUS resource configuration; receiving, from a node, a WUS transmitted on the determined resources; and determining to wake up a controller of the RIS, a surface of the RIS, or both based on the received WUS.

Clause 2: The method of Clause 1, wherein the determining to wake up the controller of the RIS, the surface of the RIS, or both is based, at least in part, on a number of bits in the received WUS.

Clause 3: The method of Clause 1 or 2, wherein the RIS is pre-configured with a default configuration via radio resource control (RRC) signaling or a medium access control (MAC)-control element (MAC-CE), the default configuration comprising an activation period and an indication to wake up the controller of the RIS, the surface of the RIS, or both for the activation period.

Clause 4: The method of Clause 3, further comprising: attempting to decode the received WUS; and wherein when the RIS fails to decode the received WUS, the determining to wake up the controller of the RIS, the surface of the RIS, or both is based, at least in part, on the default configuration.

Clause 5: The method of any of Clauses 1-4, wherein the node comprises: a network entity synchronized with the RIS; a controlling user equipment (UE) synchronized with the RIS; or a monitoring UE in sidelink communication with the controlling UE.

Clause 6: The method of any of Clauses 1-5, wherein the RIS is preconfigured with the WUS resource configuration.

Clause 7: The method of any of Clauses 1-6, wherein: the WUS is transmitted with multiple repetitions in accordance with a repetition factor and an offset; and the RIS monitors for the multiple repetitions of the WUS based, at least in part, on the repetition factor and the offset.

Clause 8: The method of Clause 7, wherein the repetition factor is defined per WUS resource, and the method further comprises: determining the repetition factor for the received WUS based, at least in part, on a WUS resource where the WUS was received.

Clause 9: The method of Clause 7 or 8, wherein the offset is configured via radio resource control (RRC) signaling or a medium access control (MAC)-control element (MAC-CE).

Clause 10: The method of any of Clauses 7-9, wherein the offset is defined in terms of a number of symbols, sub-slots, or slots.

Clause 11: The method of any of Clauses 1-10, wherein: the WUS is transmitted with multiple repetitions in accordance with a sequence-based scheme; and the RIS monitors for the multiple repetitions of the WUS based, at least in part, on the sequence-based scheme.

Clause 12: The method of any of Clauses 1-11, wherein: the WUS comprises one of: a first offset interval and a first activation period associated with the controller of the RIS, a second offset interval and a second activation period associated with the surface of the RIS; and wherein the RIS determines to: wake up the controller of the RIS after the first offset interval for the first activation period, or wake up the surface of the RIS after the second offset interval for the second activation period.

Clause 13: The method of any of Clauses 1-12, wherein: the WUS comprises one or more offset intervals and one or more activation periods associated with the controller of the RIS, the surface of the RIS, or both; and wherein the RIS determines to wake up both the controller and the surface of the RIS after the one or more offset intervals for the one or more activation periods.

Clause 14: The method of any of Clauses 1-13, wherein the WUS comprises at least one of: a beam matrix index indicating a codebook matrix for determining weight adjustments to be applied to elements on the RIS to achieve desired beamforming when the controller of the RIS, the surface of the RIS, or both are awake; or an explicit indication of the weight adjustments to be applied to the elements on the RIS to achieve the desired beamforming when the controller of the RIS, the surface of the RIS, or both are awake.

Clause 15: The method of Clause 14, further comprising: attempting to decode the received WUS; and wherein when the RIS fails to decode the received WUS, determining the weight adjustments to be applied to the elements on the RIS to achieve the desired beamforming when the controller of the RIS, the surface of the RIS, or both are awake is based, at least in part, on a preconfigured weight adjustment.

Clause 16: The method of Clause 14 or 15, wherein the beam matrix index is based, at least in part, on at least one of: a location of the surface of the RIS, a position of the surface of the RIS, or a UE to be served by the RIS.

Clause 17: The method of any of Clauses 1-16, wherein the WUS comprises an identifier (ID) of a UE to be served by the RIS, and the method further comprises: determining a previously used beam for serving the UE associated with the ID; and determining a beam to use for serving the UE based, at least in part, on the previously used beam.

Clause 18: A method for wireless communication by a node, comprising: determining resources for wake up signal (WUS)transmissions, based on a WUS resource configuration; and transmitting, to a reconfigurable intelligent surface (RIS), a WUS on the determined resources, the WUS indicating whether to wake up a controller of the RIS, a surface of the RIS, or both.

Clause 19: The method of Clause 18, wherein the WUS comprises a number of bits, the number of bits indicate whether to wake up the controller of the RIS, the surface of the RIS, or both.

Clause 20: The method of Clause 18 or 19, wherein the node comprises: a network entity synchronized with the RIS; a controlling user equipment (UE) synchronized with the RIS; or a monitoring UE in sidelink communication with the controlling UE.

Clause 21: The method of Clause 20, wherein when the node comprises a monitoring UE, the method further comprises receiving the WUS from the controlling UE.

Clause 22: The method of any of Clauses 18-21, wherein the RIS is preconfigured with the WUS resource configuration.

Clause 23: The method of claim 18, wherein the WUS is transmitted with multiple repetitions in accordance with: a repetition factor and an offset, or a sequence-based scheme.

Clause 24: The method of Clause 23, wherein: the repetition factor is defined per WUS resource, and the repetition factor for the transmitted WUS is based, at least in part, on a WUS resource where the WUS was received by the RIS.

Clause 25: The method of Clause 23 or 24, further comprising configuring the RIS with the offset via radio resource control (RRC) signaling or a medium access control (MAC)-control element (MAC-CE).

Clause 26: The method of any of Clauses 23-25, wherein the offset is defined in terms of a number of symbols, sub-slots, or slots.

Clause 27: The method of any of Clauses 18-26, wherein: the WUS comprises one of: a first offset interval and a first activation period associated with the controller of the RIS, a second offset interval and a second activation period associated with the surface of the RIS; and wherein the WUS indicates to: wake up the controller of the RIS after the first offset interval for the first activation period, or wake up the surface of the RIS after the second offset interval for the second activation period.

Clause 28: The method of any of Clauses 18-27, wherein: the WUS comprises one or more offset intervals and one or more activation periods associated with the controller of the RIS, the surface of the RIS, or both; and wherein the WUS indicates to wake up both the controller and the surface of the RIS after the one or more offset intervals for the one or more activation periods.

Clause 29: An apparatus, comprising: at least one processor; and a memory coupled to the at least one processor, the memory including instructions executable by the at least one processor to cause the apparatus to perform a method in accordance with any one of Clauses 1-28.

Clause 30: An apparatus, comprising means for performing a method in accordance with any one of Clauses 1-28.

Clause 31: A non-transitory computer-readable medium comprising executable instructions that, when executed by one or more processors of an apparatus, cause the apparatus to perform a method in accordance with any one of Clauses 1-28.

### Additional Considerations

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIG. 5 and FIG. 6.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication by a reconfigurable intelligent surface (RIS), comprising:
determining resources for wake up signal (WUS) transmissions, based on a WUS resource configuration;
receiving, from a node, a WUS transmitted on the determined resources; and
determining to wake up a controller of the RIS, a surface of the RIS, or both based on the received WUS.

2. The method of claim 1, wherein the determining to wake up the controller of the RIS, the surface of the RIS, or both is based, at least in part, on a number of bits in the received WUS.

3. The method of claim 1, wherein the RIS is pre-configured with a default configuration via radio resource control (RRC) signaling or a medium access control (MAC)-control element (MAC-CE), the default configuration comprising an activation period and an indication to wake up the controller of the RIS, the surface of the RIS, or both for the activation period.

4. The method of claim 3, further comprising:
attempting to decode the received WUS; and
wherein when the RIS fails to decode the received WUS, the determining to wake up the controller of the RIS, the surface of the RIS, or both is based, at least in part, on the default configuration.

5. The method of claim 1, wherein the node comprises:
a network entity synchronized with the RIS;
a controlling user equipment (UE) synchronized with the RIS; or
a monitoring UE in sidelink communication with the controlling UE.

6. The method of claim 1, wherein the RIS is preconfigured with the WUS resource configuration.

7. The method of claim 1, wherein:
the WUS is transmitted with multiple repetitions in accordance with a repetition factor and an offset; and
the RIS monitors for the multiple repetitions of the WUS based, at least in part, on the repetition factor and the offset.

8. The method of claim 7, wherein the repetition factor is defined per WUS resource, and the method further comprises:
determining the repetition factor for the received WUS based, at least in part, on a WUS resource where the WUS was received.

9. The method of claim 7, wherein the offset is configured via radio resource control (RRC) signaling or a medium access control (MAC)-control element (MAC-CE).

10. The method of claim 7, wherein the offset is defined in terms of a number of symbols, sub-slots, or slots.

11. The method of claim 1, wherein:
the WUS is transmitted with multiple repetitions in accordance with a sequence-based scheme; and
the RIS monitors for the multiple repetitions of the WUS based, at least in part, on the sequence-based scheme.

12. The method of claim 1, wherein:
the WUS comprises one of:
a first offset interval and a first activation period associated with the controller of the RIS,
a second offset interval and a second activation period associated with the surface of the RIS; and
wherein the RIS determines to:
wake up the controller of the RIS after the first offset interval for the first activation period, or
wake up the surface of the RIS after the second offset interval for the second activation period.

13. The method of claim 1, wherein:
the WUS comprises one or more offset intervals and one or more activation periods associated with the controller of the RIS, the surface of the RIS, or both; and
wherein the RIS determines to wake up both the controller and the surface of the RIS after the one or more offset intervals for the one or more activation periods.

14. The method of claim 1, wherein the WUS comprises at least one of:
a beam matrix index indicating a codebook matrix for determining weight adjustments to be applied to elements on the RIS to achieve desired beamforming when the controller of the RIS, the surface of the RIS, or both are awake; or
an explicit indication of the weight adjustments to be applied to 7 the elements on the RIS to achieve the desired beamforming when the controller of the RIS, the surface of the RIS, or both are awake.

15. The method of claim 14, further comprising:
attempting to decode the received WUS; and
wherein when the RIS fails to decode the received WUS, determining the weight adjustments to be applied to the elements on the RIS to achieve the desired beamforming when the controller of the RIS, the surface of the RIS, or both are awake is based, at least in part, on a preconfigured weight adjustment.

16. The method of claim 14, wherein the beam matrix index is based, at least in part, on at least one of:
a location of the surface of the RIS,
a position of the surface of the RIS, or
a UE to be served by the RIS.

17. The method of claim 1, wherein the WUS comprises an identifier (ID) of a UE to be served by the RIS, and the method further comprises:
determining a previously used beam for serving the UE associated with the ID; and
determining a beam to use for serving the UE based, at least in part, on the previously used beam.

18. A method for wireless communication by a node, comprising:
determining resources for wake up signal (WUS) transmissions, based on a WUS resource configuration; and
transmitting, to a reconfigurable intelligent surface (RIS), a WUS on the determined resources, the WUS indicating whether to wake up a controller of the RIS, a surface of the RIS, or both.

19. The method of claim 18, wherein the WUS comprises a number of bits, the number of bits indicate whether to wake up the controller of the RIS, the surface of the RIS, or both.

20. The method of claim 18, wherein the node comprises:
a network entity synchronized with the RIS;
a controlling user equipment (UE) synchronized with the RIS; or
a monitoring UE in sidelink communication with the controlling UE.

21. The method of claim 20, wherein when the node comprises a monitoring UE, the method further comprises receiving the WUS from the controlling UE.

22. The method of claim 18, wherein the RIS is preconfigured with the WUS resource configuration.

23. The method of claim 18, wherein the WUS is transmitted with multiple repetitions in accordance with:
a repetition factor and an offset, or
a sequence-based scheme.

24. The method of claim 23, wherein:
the repetition factor is defined per WUS resource, and
the repetition factor for the transmitted WUS is based, at least in part, on a WUS resource where the WUS was received by the RIS.

25. The method of claim 23, further comprising configuring the RIS with the offset via radio resource control (RRC) signaling or a medium access control (MAC)-control element (MAC-CE).

26. The method of claim 23, wherein the offset is defined in terms of a number of symbols, sub-slots, or slots.

27. The method of claim 18, wherein:
the WUS comprises one of:
a first offset interval and a first activation period associated with the controller of the RIS,
a second offset interval and a second activation period associated with the surface of the RIS; and
wherein the WUS indicates to:
wake up the controller of the RIS after the first offset interval for the first activation period, or
wake up the surface of the RIS after the second offset interval for the second activation period.

28. The method of claim 18, wherein:
the WUS comprises one or more offset intervals and one or more activation periods associated with the controller of the RIS, the surface of the RIS, or both; and
wherein the WUS indicates to wake up both the controller and the surface of the RIS after the one or more offset intervals for the one or more activation periods.

29. An apparatus for wireless communication by a user equipment (UE), comprising:
at least one processor; and
a memory coupled to the at least one processor, the memory including instructions executable by the at least one processor to cause the apparatus to:
determine resources for wake up signal (WUS) transmissions, based on a WUS resource configuration;
receive, from a node, a WUS transmitted on the determined resources; and
determine to wake up a controller of the RIS, a surface of the RIS, or both based on the received WUS.

30. An apparatus for wireless communication by a node, comprising:
at least one processor; and
a memory coupled to the at least one processor, the memory including instructions executable by the at least one processor to cause the apparatus to:
determine resources for wake up signal (WUS) transmissions, based on a WUS resource configuration; and
transmit, to a reconfigurable intelligent surface (RIS), a WUS on the determined resources, the WUS indicating whether to wake up a controller of the RIS, a surface of the RIS, or both.
